(19) United States
(12) Patent Application Publication
(10) Pub. No.: US 2026/0361787 A1
(43) Pub. Date: Nov. 12, 2026

(54) DISTRIBUTED PLACEMENT DETERMINATION PROCESS FOR A DATA PROCESSING WORKLOAD

(71) Applicant: TELEFONAKTIEBOLAGET LM ERICSSON (PUBL), Stockholm (SE)

(72) Inventors: Johan Ruuskanen, Genarp (SE); Rogelio Diaz-Mendez, Lund (SE); Stefan Håkansson, Göteborg (SE); Johan Eker, Lund (SE)

(21) Appl. No.: 19/515,271

(22) PCT Filed: Sep. 1, 2023
(86) PCT No.: PCT/IB2023/058689

§ 371 Date: Feb. 27, 2026

(51) Int. Cl. H04L 67/1023; H04L 43/0829; H04L 43/087; H04L 67/1021

(52) U.S. Cl. CPC H04L 67/1023; H04L 43/0829; H04L 43/087; H04L 67/1021

(57) ABSTRACT

Disclosed herein is a method to be performed by a first node in a network to participate in a placement determination process for a data processing workload. The data processing workload may be configured to process data originating from or near an originating node for the data processing workload. The method includes determining, for each of one or more upstream nodes, whether a forwarding condition for the upstream node is satisfied based on metadata associated with the data processing workload, transmitting, to each of one or more upstream nodes that satisfy the forwarding condition, a placement request that includes the metadata associated with the data processing workload, receiving, from each of the one or more upstream nodes that satisfy the forwarding condition, a placement response, and determining a node having a minimal cost based on information included in the placement responses received from the one or more upstream nodes.

### TECHNICAL FIELD

Embodiments of the invention relate to the field of computer networks, and more specifically to a distributed placement determination process for a data processing workload in a computer network.

### BACKGROUND

Cloud computing refers to the on-demand availability of computing resources such as central processing unit (CPU) resources and storage resources, without direct active management by the user. Large cloud infrastructures often have computing resources distributed across multiple locations (e.g., across multiple geographically distributed data centers).

Cloud computing technology has transformed the telecommunications industry. With the Fifth Generation (5G) mobile network standard, the core network is cloud-based and the industry is moving towards implementing a cloud-based radio access network (RAN). Cloud computing systems are typically built on top of commercial off-the-shelf (COTS) hardware (e.g., typically x86-based systems). This leads to potential capital expenditure savings both in terms of software and hardware. Another benefit of cloud computing technology is that it is possible to have mixed workloads. For example, cloud computing technology enables the implementation of open systems, which may support telecom applications, as well as other types of applications (e.g., integrated artificial intelligence (AI) applications running on the telecommunications platform).

In addition to being more economical, cloud computing technology also provides more flexibility. A cloud computing system may provide a virtual infrastructure that can be configured programmatically. For example, the cloud resources can be scaled up and scaled down to match current demands.

With increased flexibility comes an increased level of complexity. A modern cloud application is often built using several small independent services, which may be deployed and managed by different teams within an organization, and sometimes different organizations. When a cloud application fails or its performance degrades, it is not trivial to detect and isolate the problem. Observability frameworks (e.g., OpenTelemetry, Jaeger, etc.) may be deployed to collect data regarding the running system to help with troubleshooting. The collected data is often stored and processed at a centralized location (e.g., in a centralized data center or cloud service).

Edge computing is a distributed computing paradigm that brings computation and data storage closer to the sources of data. The use of edge computing may help reduce latency by storing and processing data at the “edge,” near the source of the data, without having to transport the data from the edge to a centralized location for processing. The lower latency enables more efficient closed loop automation.

In addition to reducing latency, the use of edge computing may help reduce bandwidth usage. The data can be processed at the edge and only the processing results (as opposed to the underlying data itself) can be sent to the centralized location for processing. The processing results typically have lower volume and velocity compared to the data itself.

The decision of when to process data at a centralized location and when to process data at the edge is dependent on the application. For an observability framework workload that collects and processes data for the purpose of monitoring the state/health of a running system, it may be desirable to place the data processing workload near the location where the data originated.

It is foreseen that in future telecommunications networks (e.g., Sixth Generation (6G) mobile networks), the data collection of observability frameworks will become more dynamic in that the amount of data that is collected and the locations at which data is collected may change over time. For example, if an anomaly is detected in a network, the observability framework may trigger more detailed data collection near the location where the anomaly was detected. This can lead to a higher volume of data being collected and thus it may be desirable to process this data locally to reduce latency and bandwidth usage. The data processing workload that is to process the data should be placed on a node that is near the location where the data is collected and that can satisfy the computing requirements and latency requirements for the data processing workload.

Currently, the decision of where to place the data processing workload is mostly a manual process. An automated solution for determining where to place a data processing workload requires having full system knowledge, which is often not feasible, particularly for a large system in which the state of the system changes over time.

Telecommunication/cellular networks are typically more distributed than traditional cloud computing systems such as those provided by public cloud providers. For example, while traditional public cloud computing systems typically have only one or a few deployment sites per country, telecommunication/cellular networks can have many more (orders of magnitude more) deployment sites per country at which its cloud computing infrastructure is deployed.

### SUMMARY

An embodiment disclosed herein is a method performed by a first node in a network to participate in a placement determination process for a data processing workload. The data processing workload may be configured to process data originating from or near an originating node for the data processing workload. The method includes determining that the first node is to participate in a placement determination process for the data processing workload, responsive to determining that the first node is to participate in the placement determination process for the data processing workload, determining, for each of one or more upstream nodes, whether a forwarding condition for the upstream node is satisfied based on metadata associated with the data processing workload, transmitting, to each of one or more upstream nodes that satisfy the forwarding condition, a placement request that includes the metadata associated with the data processing workload, receiving, from each of the one or more upstream nodes that satisfy the forwarding condition, a placement response, and determining a node having a minimal cost based on information included in the placement responses received from the one or more upstream nodes that satisfy the forwarding condition.

An embodiment disclosed herein is a non-transitory machine-readable medium comprising computer program code which when executed by a network device functioning as a first node in a network carries out operations for participating in a placement determination process for a data processing workload. The data processing workload may be configured to process data originating from or near an originating node for the data processing workload. The operations include determining that the first node is to participate in a placement determination process for the data processing workload, responsive to determining that the first node is to participate in the placement determination process for the data processing workload, determining, for each of one or more upstream nodes, whether a forwarding condition for the upstream node is satisfied based on metadata associated with the data processing workload, transmitting, to each of one or more upstream nodes that satisfy the forwarding condition, a placement request that includes the metadata associated with the data processing workload, receiving, from each of the one or more upstream nodes that satisfy the forwarding condition, a placement response, and determining a node having a minimal cost based on information included in the placement responses received from the one or more upstream nodes that satisfy the forwarding condition.

An embodiment is a network device to function as a first node in a network to participate in a placement determination process for a data processing workload. The data processing workload may be configured to process data originating from or near an originating node for the data processing workload. The network device includes one or more processors and a non-transitory machine-readable storage medium that stores instructions, which when executed by the one or more processors, causes the first node to perform operations for participating in a placement determination process for a data processing workload. The operations include determining that the first node is to participate in a placement determination process for the data processing workload, responsive to determining that the first node is to participate in the placement determination process for the data processing workload, determining, for each of one or more upstream nodes, whether a forwarding condition for the upstream node is satisfied based on metadata associated with the data processing workload, transmitting, to each of one or more upstream nodes that satisfy the forwarding condition, a placement request that includes the metadata associated with the data processing workload, receiving, from each of the one or more upstream nodes that satisfy the forwarding condition, a placement response, and determining a node having a minimal cost based on information included in the placement responses received from the one or more upstream nodes that satisfy the forwarding condition.

### BRIEF DESCRIPTION OF THE DRAWINGS

The invention may best be understood by referring to the following description and accompanying drawings that are used to illustrate embodiments of the invention. In the drawings:

FIG. 1 is a diagram showing a node and operations performed by the node to participate in a placement determination process for a data processing workload, according to some embodiments.

FIG. 2 is a diagram showing placement requests and placement responses for a data processing workload being sent between nodes in a mobile network, according to some embodiments.

FIG. 3 is a flow diagram of a method for participating in a placement determination process for a data processing workload, according to some embodiments.

FIG. 4 is a flow diagram showing operations for determining whether a forwarding condition for an upstream node is satisfied, according to some embodiments.

FIG. 5 is a flow diagram showing operations for determining an updated local state, according to some embodiments.

FIG. 6 is a diagram showing a mobile network that includes network devices that can implement embodiments disclosed herein.

FIG. 7 is a diagram showing examples of how network devices may be implemented in some embodiments.

### DETAILED DESCRIPTION

The following description describes methods and apparatus for a distributed way of determining a placement for a data processing workload. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments. However, such notation should not be taken to mean that these are the only options or optional operations, and/or that blocks with solid borders are not optional in certain embodiments.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send/transmit and receive data whether over a wired and/or a wireless connection. In some embodiments, a physical NI may comprise radio circuitry capable of receiving data from other electronic devices over a wireless connection and/or sending/transmitting data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

A mobile network (e.g., a Fifth Generation (5G) mobile network) may include multiple computing nodes that are connected to each other. Some nodes may be connected to a base station of the mobile network (e.g., a gNodeB). When a fault is detected at a base station, a data processing workload may be deployed near the faulty base station to process observability data collected near the base station. The data processing workload may analyze the data to determine what caused the fault, and in some cases, to determine how to remedy the fault. The data processing workload may leverage artificial intelligence (AI) techniques to process the data.

A decision has to be made regarding where to place the data processing workload in the mobile network. Some nodes of the mobile network will be more suitable than others to execute the data processing workload. To capture this concept, each node may be assigned a notion of cost for executing the data processing workload at that node. The cost may be a freely defined, abstract, single-valued parameter that can be determined based on the actual monetary cost per compute and/or data transfer, the stability of the latencies, and/or other factors. The mobile network operator (or other administrator/authority) may define how the cost is determined. A data processing workload is assumed to have some requirements related to the node resources (e.g., central processing unit (CPU), memory, random access memory (RAM), and storage resources that are needed to execute the data processing workload) and link characteristics (e.g., latency, bandwidth, and/or jitter of the links along the path that the data has to traverse to reach the data processing workload). As such, the problem of determining where to place a data processing workload may involve finding a node that can satisfy the requirements for the data processing workload (e.g., computing requirement and link requirement) while minimizing some predefined notion of cost.

In very large mobile networks, such as those foreseen with the advent of Sixth Generation (6G) mobile networks, finding the “best” node on which to place a data processing workload is non-trivial. Since the load on the nodes and links are dynamic, maintaining global knowledge of the states of all nodes and links in the mobile network is not feasible at scale due to the sheer amount of computing power and bandwidth required to aggregate what could be a large volume of data. Also, the topology of the mobile network and the node characteristics are typically not static, which makes maintaining global knowledge all the more difficult. For example, new nodes can be added, existing nodes can be removed, and node resources can be upgraded/downgraded.

Embodiments are described herein that can determine a placement for a data processing workload in a network that satisfies the requirements for the data processing workload and that minimizes a notion of cost, without having to maintain global knowledge of the topology and state of the network. Embodiments achieve this by searching within a local neighborhood for a node that is suitable for executing the data processing workload. The placement determination process for the data processing workload is performed in a distributed manner.

According to some embodiments, an originating node may initiate a placement determination process for a data processing workload. The originating node may be the source of the data that the data processing workload is to operate on (or a node that is near the source of the data). The originating node may initiate the placement determination process by transmitting placement requests to any of its upstream nodes that satisfy a forwarding condition (examples of the forwarding condition are described in further detail below). As used herein, the term “upstream” refers to a direction that goes away from the originating node. As used herein, the term “downstream” refers to a direction going towards the originating node. A placement request sent by the originating node may include metadata. The metadata may include an identifier associated with the data processing workload (e.g., a universally unique identifier (UUID)—this may be helpful when determining whether a node has already been visited for a particular request), a computing requirement for the data processing workload, a link requirement for the data processing workload, and/or a maximum allowed distance. The computing requirement for the data processing workload may include CPU, memory, and/or storage requirements. The link requirement for the data processing workload may include a link latency requirement, a link loss requirement, a link jitter requirement, and a link bandwidth requirement. The maximum allowed distance may indicate the number of “hops” or “jumps” that can be made until the search process ends.

A node may receive a placement request from a downstream node (the node that receives the placement request may be referred to in this context as the current node). The placement request received by the current node may include local state and the metadata. The local state may include an aggregated link metric and a current distance from the originating node. The aggregated link metric may include an aggregated link latency, an aggregated link loss, and/or an aggregated link jitter. The current distance indicates a distance between the current node and the originating node. For example, the current distance could correspond to the number of nodes between the originating node and the current node. In general, the local state includes information that is updated as placement requests are propagated upstream, whereas the metadata includes information that is expected to stay the same during the placement determination process.

Responsive to receiving the placement request, the current node may determine whether there are any upstream nodes that satisfy the forwarding condition. The current node may determine that an upstream node satisfies the forwarding condition if:
(1) the upstream node has not already been visited;
(2) the aggregated link metric satisfies the link requirement for the data processing workload;
(3) the link between the current node and the upstream node has sufficient bandwidth; and
(4) the maximum allowed distance has not been reached yet.

If there is at least one upstream node that satisfies the forwarding condition, the current node may transmit placement requests to those upstream nodes. The current node may include an updated local state (e.g., that includes an updated aggregated link metric and updated current distance) in the placement request that it transmits to an upstream node. If there are no upstream nodes that satisfy the forwarding condition, the current node may transmit a placement response to the downstream node without transmitting any placement requests to upstream nodes. The placement response may include information regarding the node determined by the current node as having the minimal cost, which could be itself or “none” (e.g., if the current node does not have sufficient computing resources to satisfy the computing requirement for the data processing workload).

If the current node transmits placement responses to the upstream nodes (e.g., because at least one upstream node satisfied the forwarding condition), it may later receive placement responses from those upstream nodes. A placement response received from an upstream node may include information regarding the node determined by that upstream node as having minimal cost. The current node may then determine the node having minimal cost based on the information included in the placement responses received from the upstream nodes. The current node may determine that the node having the minimal cost is one of the nodes determined by the upstream nodes as having the minimal cost or the current node itself. The current node may then transmit a placement response to the downstream node that includes information regarding the node determined by the current node as having minimal cost.

Eventually, the originating node may receive placement responses from its upstream nodes. The originating node may determine the node having the minimal cost based on the information included in the received placement responses. This will be the node having minimal cost within the search area (among the nodes that participated in the placement determination process). The originating node may then cause the data processing workload to be placed on the determined node.

The placement determination process is distributed in nature with each participating node making a local determination of the node having minimal cost based on information received from its upstream nodes (if any) and propagating information regarding the node determined to have minimal cost downstream towards the originating node.

A technical advantage of the placement determination process disclosed herein is that it does not rely on having complete system knowledge (e.g., in contrast to existing placement determination solutions that require knowing the complete topology and current state of the network). The placement determination process disclosed herein searches the nodes in the local neighborhood of the data source to find a node that satisfies the requirements for the data processing workload and minimizes some notion of cost. Unlike prior approaches, the placement determination process disclosed herein does not require maintaining centralized state, but instead captures the current state of the network (e.g., current resource utilization/availability) through a local gossip-style protocol.

Advantageously, due to its distributed nature, the placement determination process can deal with reconfigurations and changes to the network state without requiring central coordination. Also, due to its distributed nature, the placement determination process disclosed herein scales well, which makes it suitable for use in large networks. Therefore, by using the disclosed techniques, an individual node in the network can determine where to place a data processing workload without having to communicate with and coordinate with a central controller and the system does not have to maintain centralized state information or use centralized coordination during the placement determination process. As a result, the system avoids the need to transfer data to/from a central controller from various nodes in the system, which reduces bandwidth usage as well as overall processing times when placing a workload within the system. A large mobile network may include in the order of hundreds of thousands of nodes, which makes a centralized solution that requires complete system knowledge infeasible. While certain advantages are highlighted above, those skilled in the relevant art will appreciate that embodiments can provide other advantages in view of the present disclosure.

In an embodiment, multiple placement determination processes for multiple data processing workloads can be executed in parallel, leading to speed improvement and full scalability since the process does not require central coordination.

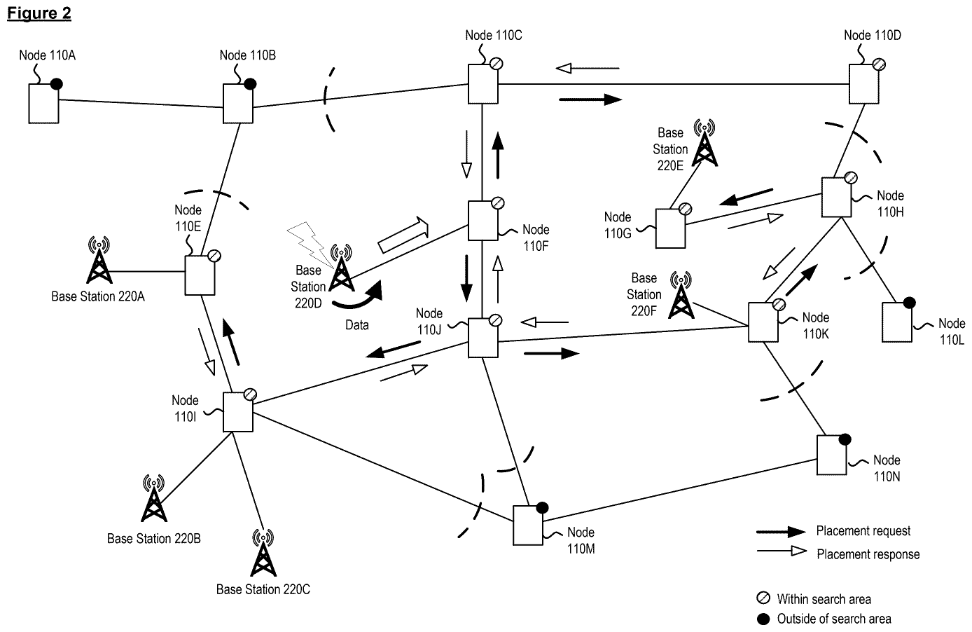

For the sake of illustration/explanation, embodiments are primarily described herein in the context of a mobile network that includes nodes connected by links such as the mobile network shown in FIG. 2. Each node is assumed to have its own set of available computing resources (e.g., CPU, memory, storage, etc.) and each link is assumed to have its own characteristics (e.g., latency, throughput, jitter, bandwidth, etc.). In a mobile network context, nodes may be base stations, virtual switches, servers, a cloud computing node, or the like. It should be appreciated that embodiments are not limited to being used in mobile networks but can be used in other types of distributed systems. Also, for the sake of illustration/explanation, embodiments are primarily described for the use case of an observability framework application that deploys a data processing workload to process (observability) data collected from a particular location in the network (e.g., a location at which an anomaly or fault was detected).

However, it should be appreciated that embodiments can be adapted for use with other use cases. Embodiments can be used to build a dynamic data pipeline that can transport data from the source of the data to the data processing workload that is to process the data. Embodiments are further described herein with reference to the accompanying figures.

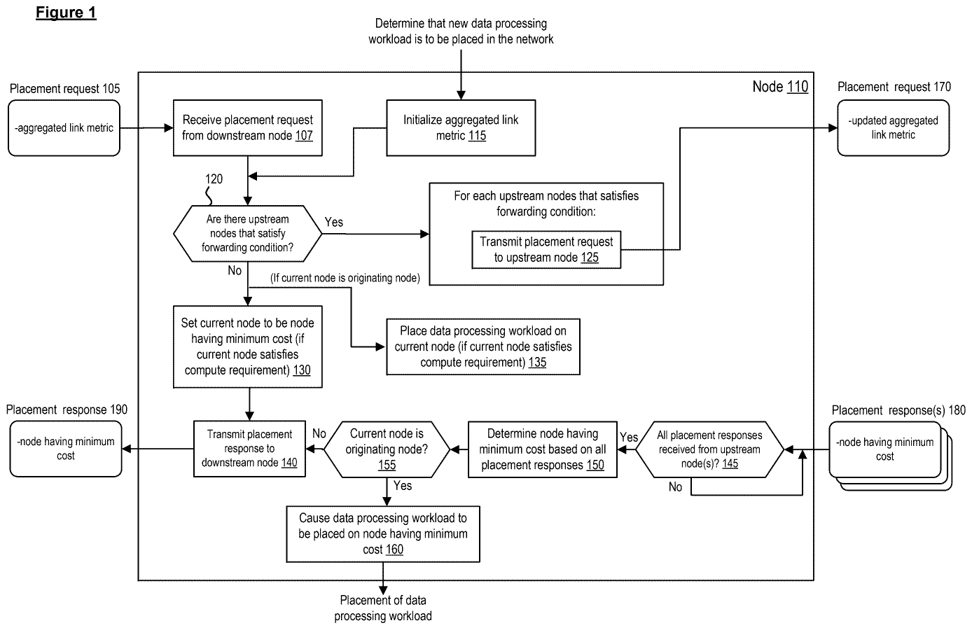

FIG. 1 is a diagram showing a node and operations performed by the node to participate in a placement determination process for a data processing workload, according to some embodiments. The node 110 shown in the diagram may be referred to in the description below as the “current” node. However, those skilled in the art will understand that the current node could be any given node that is currently participating in the placement determination process.

In an embodiment, the current node 110 participates in the placement determination process for the data processing workload due to the current node 110 determining that a new data processing workload is to be placed in the network. In this scenario, the current node 110 is considered to be the originating node for the data processing workload. As an example, the current node 110 may determine that a new data processing workload is to be placed in the network if an anomaly or fault was detected near the current node 110 and an observability framework decides to collect data generated at or near the current node 110 and analyze that data to determine the cause of the anomaly or fault. As another example, the current node 110 could determine that a new data processing workload is to be placed in the network based on receiving user input/instructions (e.g., from a network administrator) to deploy a new data processing workload in the network or based on detecting an event that requires the deployment of the new data processing workload in the network.

If the current node 110 determines that a new data processing workload is to be placed, at operation 115, the current node 110 initializes an aggregated link metric. The initialized aggregated link metric may include initial values (e.g., zero values) for an aggregated link latency, an aggregated link loss, and/or an aggregated link jitter. As will be described further herein, the aggregated link metric may be updated as placement requests are propagated upstream to reflect the combined characteristics of the links along the current path. The current node 110 may then proceed to performing operation 120.

In an embodiment, the current node 110 participates in the placement determination process for the data processing workload due to receiving a placement request 105 from a downstream node (operation 107). The placement request 105 may include an aggregated link metric. The aggregated link metric may include an aggregated link latency, an aggregated link loss, and/or an aggregated link jitter. This aggregated link metric may reflect the combined characteristics of the links along the current path from the originating node to the current node 110. The node 110 may then proceed to performing operation 120.

At operation 120, the current node 110 determines whether there are any upstream nodes that satisfy the forwarding condition. If there is at least one upstream node that satisfies the forwarding condition, at operation 125, the current node 110 transmits a placement request to each upstream node that satisfies the forwarding condition. The placement request 170 may include an updated aggregated link metric (e.g., to take into account the characteristics of the link between the current node 110 and the upstream node). The updated aggregated link metric may include updated values for an aggregated link latency, an aggregated link loss, and/or an aggregated link jitter. Although not shown in the diagram, placement requests (e.g., placement requests 105 and 170) may include metadata associated with the data processing workload such as an identifier associated with the data processing workload, a computing requirement for the data processing workload, a link requirement for the data processing workload, a maximum allowed distance, and/or the like. In various embodiments, the metadata includes information that is used as part of determining whether an upstream node satisfies a forwarding condition.

Returning to operation 120, if there are no upstream nodes that satisfy the forwarding condition and the current node 110 is not the originating node, then at operation 130, the current node 110 sets itself to be the node having minimal cost (assuming that the current node 110 satisfies the computing requirement for the data processing workload). At operation 140, the node 110 transmits a placement response to the downstream node. The placement response 190 may include information regarding the node determined by the current node 110 as having minimal cost (which in this case would be the current node 110 itself). Returning to operation 120, if there are no upstream nodes that satisfy the forwarding condition and the current node 110 is the originating node, then at operation 135, the current node 110 places the data processing workload on itself (assuming that the current node satisfies the computing requirement for the data processing workload).

After transmitting placement requests 170 to one or more upstream nodes, the current node 110 may receive placement response(s) 180 from the upstream nodes. Each placement response 180 received from an upstream node may include information regarding the node determined by that upstream node as having minimal cost. This information may include an identifier associated with the minimal cost node and the cost associated with the minimal cost node. In an embodiment, this information may also include information regarding the computing resources available at the minimal cost node and/or information regarding the link characteristics of the links on the path between the originating node and the minimal cost node, and/or other information.

At operation 145, the current node 110 determines whether all placement responses have been received from the upstream nodes. If the current node 110 has not received all placement response from the upstream nodes, then the current node 110 waits until it has received all of the placement responses. Once the current node 110 has received all placement responses from the upstream nodes, at operation 150, the current node 110 determines the node having minimal cost based on the information included in the received placement responses. The node having minimal cost may be one of the nodes determined by the upstream nodes as having minimal cost or the current node 110 itself.

At operation 155, the current node 110 determines whether it is the originating node for the data processing workload. If the current node 110 determines that it is the originating node for the data processing workload, then at operation 160, the current node 110 causes the data processing workload to be placed on the node that it determined as having minimal cost.

Returning to operation 155, if the current node 110 determines that it is not the originating node for the data processing workload, then at operation 140, the current node 110 transmits a placement response to the downstream node. The placement response 190 may include information regarding the node determined by the current node 110 as having minimal cost (e.g., the ID associated with that node and the cost associated with that node).

In various embodiments, the different nodes (e.g., the current node 110, the upstream nodes, and the downstream node) can implement the same logic shown in the diagram, which helps simplify implementation. Any node may initiate a placement determination process for a data processing workload. The placement determination process allows the originating node to find a node that satisfies the requirements for the data processing workload (e.g., the computing and link requirements for the data processing workload) and that has minimal cost within a local search area.

FIG. 2 is a diagram showing placement requests and placement responses for a data processing workload being sent between nodes in a mobile network, according to some embodiments.

As shown in the diagram, the mobile network includes base stations 220A-E and nodes 110A-N that are communicatively coupled to each other. In this example, a fault detected at base station 220D (depicted in the diagram as a lightning bolt) triggers node 110F, which is connected to base station 220D, to initiate a new placement determination process for a data processing workload. Node 110F initiates the placement determination process by transmitting placement requests to upstream nodes 110C and 110J (e.g., because these nodes satisfy the forwarding condition). Node 110F is considered to be the originating node for this placement determination process. Responsive to receiving the placement request from node 110F, node 110C transmits a placement request to node 110D. In this example, it is assumed that node 110C determined that node 110B does not satisfy the forwarding condition so node 110C does not transmit a placement request to node 110B.

Responsive to receiving the placement request from node 110C, node 110D determines that there are no upstream nodes that satisfy the forwarding condition. As such, node 110D transmits a placement response to node 110C without transmitting any placement responses to upstream nodes. The placement response may include information regarding the node determined by node 110D as having minimal cost (which could be itself or “none” (e.g., if node 110D does not satisfy the computing requirement for the data processing workload)).

Responsive to receiving the placement response from node 110D, node 110C may determine the node having minimal cost based on information included in the received placement response (which could be node 110C, node 110D, or “none”). Node 110C may then transmit a placement response to node 110F that includes information regarding the node determined by node 110C as having minimal cost.

Responsive to receiving the placement request from node 110F, node 110J transmits a placement request to node 110I and node 110K. In this example, it is assumed that node 110J determined that node 110M does not satisfy the forwarding condition so node 110J does not transmit a placement request to node 110M.

Responsive to receiving the placement request from node 110J, node 110I transmits a placement request to node 110E. In this example, it is assumed that node 110I determined that node 110M does not satisfy the forwarding condition so node 110I does not transmit a placement request to node 110M.

Responsive to receiving the placement request from node 110I, node 110E determines that there are no upstream nodes that satisfy the forwarding condition. As such, node 110E transmits a placement response to node 110I without transmitting any placement responses to upstream nodes. The placement response may include information regarding the node determined by node 110E as having minimal cost (which could be itself or “none” (e.g., if node 110E does not satisfy the computing requirement for the data processing workload)).

Responsive to receiving the placement response from node 110E, node 110I may determine the node having minimal cost based on information included in the received placement response (which could be node 110E, node 110I, or “none”). Node 110I may then transmit a placement response to node 110J that includes information regarding the node determined by node 110I as having minimal cost.

Responsive to receiving the placement request from node 110J, node 110K transmits a placement request to node 110H. In this example, it is assumed that node 110K determined that node 110N does not satisfy the forwarding condition so node 110K does not transmit a placement request to node 110N.

Responsive to receiving the placement request from node 110K, node 110H transmits a placement request to node 110G. In this example, it is assumed that node 110H determined that node 110L does not satisfy the forwarding condition so node 110H does not transmit a placement request to node 110L.

Responsive to receiving the placement request from node 110H, node 110G determines that there are no upstream nodes that satisfy the forwarding condition. As such, node 110G transmits a placement response to node 110H without transmitting any placement responses to upstream nodes. The placement response may include information regarding the node determined by node 110G as having minimal cost (which could be itself or “none” (e.g., if node 110G does not satisfy the computing requirement for the data processing workload)).

Responsive to receiving the placement response from node 110G, node 110H may determine the node having minimal cost based on information included in the received placement response (which could be node 110G, node 110H, or “none”). Node 110H may then transmit a placement response to node 110K that includes information regarding the node determined by node 110H as having minimal cost.

Responsive to receiving the placement response from node 110H, node 110K may determine the node having minimal cost based on information included in the received placement response (which could be node 110G, node 110H, node 110K, or “none”).

Node 110K may then transmit a placement response to node 110J that includes information regarding the node determined by node 110K as having minimal cost.

Node 110J previously sent placement requests to both node 110I and node 110K. Thus, node 110J may receive placement responses from both node 110I and node 110J. Responsive to receiving placement responses from node 110I and node 110K, node 110J may determine the node having minimal cost based on information included in the received placement responses (which could be node 110E, node 110I, node 110G, node 110H, node 110K, node 110J, or “none”). Node 110J may then transmit a placement response to node 110F that includes information regarding the node determined by node 110J as having minimal cost.

Node 110F previously sent placement requests to both node 110C and node 110J. Thus, node 110C may receive placement responses from both node 110C and node 110J. Responsive to receiving placement responses from node 110C and node 110J, node 110F may determine the node having minimal cost based on information included in the received placement responses (which could be node 110E, node 110I, node 110G, node 110H, node 110K, node 110J, node 110D, node 110C, or “none”). Since node 110F is the originating node, node 110F may cause the data processing workload to be placed on the node determined by node 110F as having minimal cost. If there is no node that satisfies the requirements for the data processing workload, then node 110F may indicate as such so that appropriate action can be taken (e.g., the requirements can be relaxed or additional resources can be provisioned to nodes).

In this way, the originating node 110F may be able to find a node within a search area that satisfies the requirements for the data processing workload and that has minimal cost. In the example shown in the diagram, the search area includes the nodes annotated with striped circles. The nodes annotated in the diagram with solid circles are outside of the search area. The dashed arcs shown in the diagram indicate the boundaries of the search area.

In an embodiment, the size of the search area can be controlled indirectly by adjusting the link requirement for the data processing workload (e.g., relaxing the link latency requirement to allow for longer latencies may result in increasing the size of the search area) or controlled directly by setting the maximum allowed distance. There is a trade-off involved with the size of the search area. A larger search area considers more nodes for placement, which might help with minimizing the cost, but may result in slower execution times.

In an embodiment, the placement requests include a unique identifier (e.g., a universally unique identifier (UUID)) associated with the data processing workload. The inclusion of the unique identifier makes it possible to determine which nodes have already been visited for the placement determination process of a particular data processing workload. For example, each node that is visited as part of the placement determination process for a particular data processing workload may store the unique identifier associated with the data processing workload to keep a record that it has already been visited as part of the placement determination process for the particular data processing workload. The inclusion of the unique identifier allows for multiple placement determination processes (e.g., for multiple different data processing workloads) to be performed simultaneously (e.g., nodes can keep track of the different placement determination processes using the UUIDs of the data processing workloads).

In an embodiment, once the originating node determines the node having minimal cost, the originating node may configure a path from the originating node to the node have minimal cost (e.g., path information may be included in the placement responses) so that data can be sent along this path from the originating node to the node having minimal cost (and possibly in the reverse direction as well). For example, the path can be walked from node to node, and the required computing resources (e.g., CPU, memory, and storage) and link resources (e.g., bandwidth) can be configured/reserved along the way at each node. The final node along the path (i.e., the node determined to have minimal cost) may deploy the data processing workload. The data processing workload may receive data from the originating node over the path and process the data (e.g., analyze the data to determine what caused the fault that occurred at or near the originating node). In an embodiment, the data processing workload may then transmit the processing results to a centralized location for further processing.

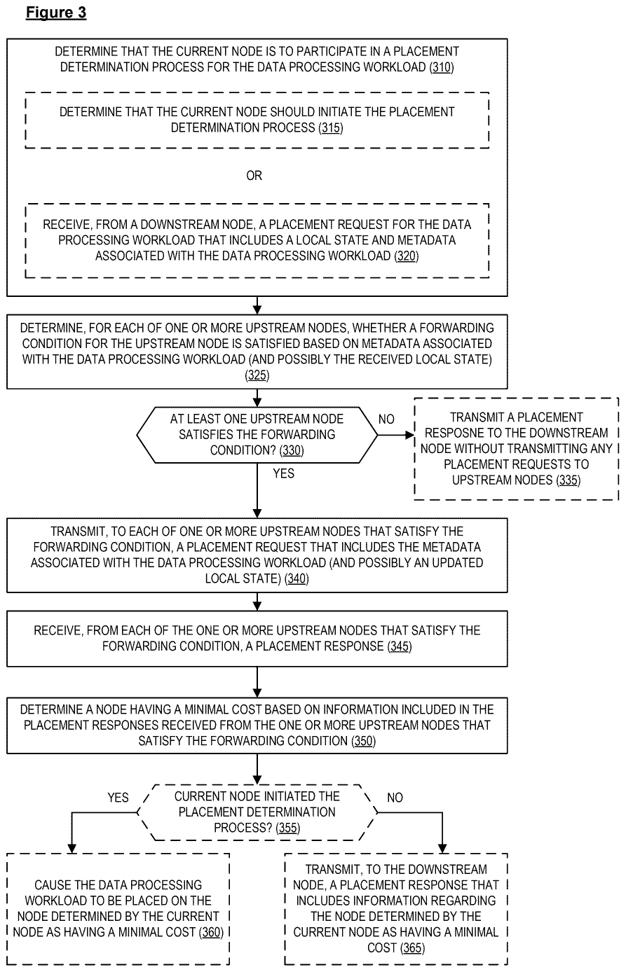

FIG. 3 is a flow diagram of a method for participating in a placement determination process for a data processing workload, according to some embodiments. In an embodiment, the method is performed by a node in a network. This node may be referred to as the “current node” in the description of the flow diagram. In an embodiment, the current node is a cloud computing node of a mobile network. The data processing workload may be configured to process data originating from or near an originating node for the data processing workload.

The operations in the flow diagrams will be described with reference to the exemplary embodiments of the other figures. However, it should be understood that the operations of the flow diagrams can be performed by embodiments other than those discussed with reference to the other figures, and the embodiments discussed with reference to these other figures can perform operations different than those discussed with reference to the flow diagrams.

Also, while the flow diagrams in the figures show a particular order of operations performed by certain embodiments, it should be appreciated that such order is provided by way of example and not intended to be limiting (e.g., alternative embodiments may perform the operations in a different order, combine certain operations, overlap certain operations, etc.).

At operation 310, the current node determines that it is to participate in a placement determination process for the data processing workload.

In an embodiment, as shown by operation 315, the determination by the current node that it is to participate in the placement determination process for the data processing workload is based on the current node determining that it should initiate a placement determination process for the data processing workload. In this case, the current node is the originating node for the placement determination process. In some embodiments, the current node determines that it should initiate the placement determination process for the data processing workload based on detecting an anomaly or fault near the current node. In this case, the data processing workload may be a workload of an observability framework that analyzes network telemetry data to determine the cause of the anomaly or fault. In some embodiments, the current node determines that it should initiate the placement determination process for the data processing workload based on receiving a request, user input/instructions (e.g., from a network administrator), and/or the like that indicates a placement determination process should be initiated. In some embodiments, the current node determines that it should initiate the placement determination process based on detecting an event that requires the deployment of a new data processing workload in the network.

In an embodiment, as shown by operation 320, the determination by the current node that it is to participate in the placement determination process for the data processing workload is in response to the current node receiving, from a downstream node, a placement request for the data processing workload. As discussed above, the term “downstream” refers to a direction going towards the originating node. That is, the current node determines that it should participate in the placement determination process in response to receiving a placement request from the originating node or another node that is between the originating node and the current node. The originating node is the node that first initiated the placement determination process for the data processing workload. In some embodiments, the placement request received from the downstream node includes a local state and/or metadata associated with the data processing workload. In general, the local state includes information that is updated as placement requests are propagated upstream, whereas the metadata includes information that is expected to stay the same during the placement determination process. In an embodiment, the local state included in the placement request received from the downstream node includes an aggregated link metric. In an embodiment, the metadata associated with the data processing workload includes an identifier associated with the data processing workload, a computing requirement for the data processing workload, and a link requirement for the data processing workload. In an embodiment, the local state included in the placement request received from the downstream node further includes a current distance from the originating node and the metadata associated with the data processing workload further includes a maximum allowed distance.

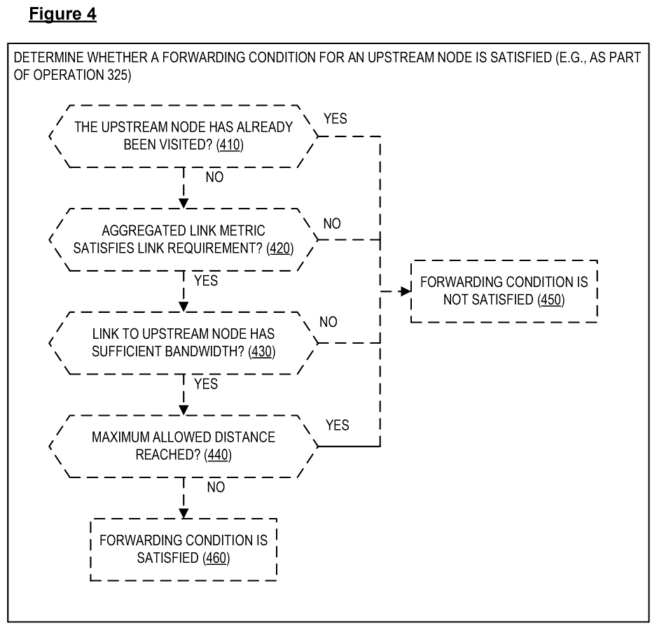

Responsive to determining that it is to participate in the placement determination process for the data processing workload, at operation 325, the current node determines, for each of one or more upstream nodes, whether a forwarding condition for the upstream node is satisfied based on metadata associated with the data processing workload. Example operations for determining whether a forwarding condition for an upstream node is satisfied are shown in FIG. 4 and described with reference thereto below. As discussed above, the term “upstream” refers to a direction that goes away from the originating node.

In embodiments where the current node received a placement request for the data processing workload from a downstream node, the determination of whether the forwarding condition is satisfied for an upstream node may be further based on the local state included in the placement request received from the downstream node. FIG. 4 shows example operations that may be involved with determining whether a forwarding condition for an upstream node is satisfied.

At operation 330, the current node determines whether at least one upstream node satisfies the forwarding condition. In an embodiment, if the current node determines that there are no upstream nodes that satisfy the forwarding condition, at operation 335, the current node transmits a placement response to the downstream node without transmitting any placement requests to upstream nodes. The placement response may indicate that the current node is the node determined to have minimal cost (assuming the current node satisfies the computing requirement for the data processing workload).

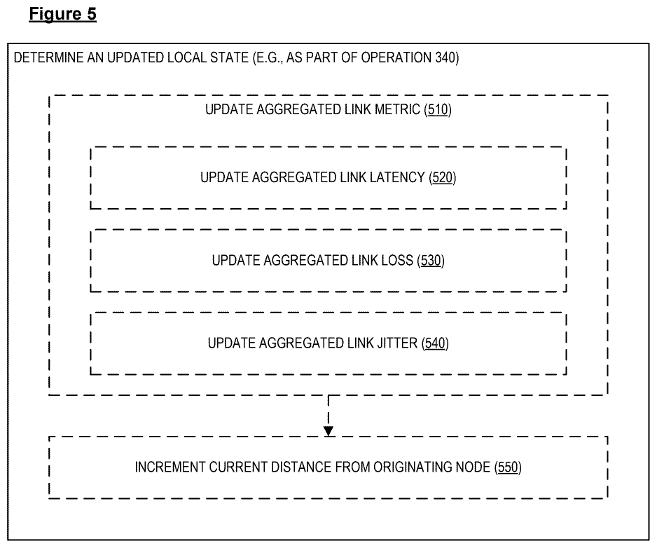

Otherwise, if the current node determines that at least one upstream node satisfies the forwarding condition, at operation 340, the current node transmits, to each of one or more upstream nodes that satisfy the forwarding condition, a placement request that includes the metadata associated with the data processing workload. The placement request may also include an updated local state (e.g., if the current node received a placement request for the data processing workload (including a local state) from a downstream node). FIG. 5 shows example operations that may be involved with determining an updated local state.

At operation 345, the current node receives, from each of the one or more upstream nodes that satisfy the forwarding condition, a placement response. The placement response received from an upstream node may include information regarding the node determined by the upstream node as having minimal cost. This information may include the ID associated with that node determined by the upstream node as having minimal cost and the cost associated with that node.

At operation 350, the current node determines a node having a minimal cost based on information included in the placement responses received from the one or more upstream nodes that satisfy the forwarding condition. The cost of a node may reflect the monetary cost for performing computing operations on the node, the monetary cost for performing data transfers to/from the node, the stability of the latencies to/from the node, and/or other factors.

In an embodiment, at operation 355, the current node determines whether it initiated the placement determination process. In an embodiment, if the current node initiated the placement determination process (such that the current node is the originating node for the placement determination process), then at operation 360, the current node causes the data processing workload to be placed on the node that it (the current node) determined as having a minimal cost. In an embodiment, if the current node did not initiate the placement determination process, then at operation 365, the current node transmits, to the downstream node, a placement response that includes information regarding the node that it (the current node) determined as having a minimal cost.

FIG. 4 is a flow diagram showing operations for determining whether a forwarding condition for an upstream node is satisfied, according to some embodiments. The operations of the flow diagram may be performed by the current node as part of performing operation 325 shown in FIG. 3.

At operation 410, the current node determines whether the upstream node has already been visited by the placement determination process. If the upstream neighbor has already been visited, then at operation 450, the current node determines that the forwarding condition is not satisfied for the upstream node. The current node may determine whether the upstream neighbor has already been visited based on checking with the upstream neighbor whether the upstream neighbor has received a placement request for the data processing workload. For example, the current node could leverage the (unique) identifier associated with the data processing workload, as described above, to check whether the upstream neighbor has already received a placement request corresponding to the identifier. Otherwise, if the upstream neighbor has not been visited yet, then the flow moves to operation 420.

At operation 420, the current node determines whether an aggregated link metric satisfies the link requirement. If the aggregated link metric does not satisfy the link requirement, then at operation 450, the current node determines that the forwarding condition is not satisfied for the upstream node. Otherwise, if the aggregated link metric satisfies the link requirement, then the flow moves to operation 430. The aggregated link metric may reflect the combined characteristics of the links along the current path from the originating node to the current node. In an embodiment, the aggregated link metric includes one or more of: an aggregated link latency, an aggregated link loss, and an aggregated link jitter. In some embodiments, the current node determines whether the aggregated link metric satisfies the link requirement based on comparing the aggregated link metric to the link requirement. For example, the current node could check whether the aggregated link latency is longer than the maximum allowed link latency.

At operation 430, the current node determines whether a link to the upstream node has sufficient bandwidth. If the link to the upstream node does not have sufficient bandwidth, then at operation 450, the current node determines that the forwarding condition is not satisfied for the upstream node. Otherwise, if the link to the upstream node has sufficient bandwidth, then the flow moves to operation 440.

At operation 440, the current node determines whether a maximum allowed distance has been reached. If the maximum allowed distance has been reached, then at operation 450, the current node determines that the forwarding condition is not satisfied for the upstream node. Otherwise, if the maximum allowed distance has not been reached, then at operation 460, the current node determines that the forwarding condition is satisfied for the upstream node. In some embodiments, the current node determines whether the maximum allowed distance has been reached based on comparing the current distance from the originating node to the maximum allowed distance.

FIG. 5 is a flow diagram showing operations for determining an updated local state, according to some embodiments. The operations of the flow diagram may be performed by a current node as part of performing operation 340 shown in FIG. 3.

At operation 510, the current node updates an aggregated link metric. In an embodiment, as shown by operation 520, updating the aggregated link metric involves updating an aggregated link latency. For example, the current node could add the link latency of the link between the current node and the upstream node to the aggregated link latency included in the local state received from the downstream node. In an embodiment, as shown by operation 530, updating the aggregated link metric involves updating an aggregated link loss. As an example, the current node could combine the link loss of the link between the current node and the upstream node and the aggregated link loss included in the local state received from the downstream node. In an embodiment, as shown by operation 540, updating the aggregated link metric involves updating an aggregated link jitter. For example, the current node could combine the link jitter of the link between the current node and the upstream node and the aggregated link jitter included in the local state received from the downstream node.

At operation 550, the current node increments a current distance from the originating node. For example, as discussed above, the current node could receive local state information from a downstream node. The local state information indicates the (previous) current distance, i.e., the distance between the downstream node and the originating node. The current node may increment the current distance that was received from the downstream node to generate an updated current distance that corresponds to the distance between the current node and the originating node.

Embodiments described herein can be used to determine a placement for a data processing workload that is to operate on data originating at or near an originating node. Embodiments can be used in any type of distributed system that can be represented as a graph of nodes and links. Embodiments consider end-to-end constraints such as the latency of the data pipeline (between the data source and the node that executes the data processing workload). Embodiments operate in a distributed fashion. Each node participating in the placement determination process can implement the same logic. Embodiments described herein can be seen as performing a bottom-up local search centered around a data source to find a viable placement for a data processing workload that minimizes some notion of cost (e.g., where the notion of cost can be defined differently depending on the use case). The search is not exhaustive but may end after a pre-defined number of “jumps” are made or when an aggregated link metric no longer satisfies the link requirement for the data processing workload, which makes the placement determination process efficient and avoids the need to maintain global network state. Multiple placement determination processes can be performed simultaneously without having to maintain global network state.

Embodiments may be implemented in an Open RAN (O-RAN) environment. O-RAN defines an architecture with different units (e.g., Central Unit, Distributed Unit, and Remote Unit). Each unit may be considered a “node” for purposes of determining a placement for a data processing workload.

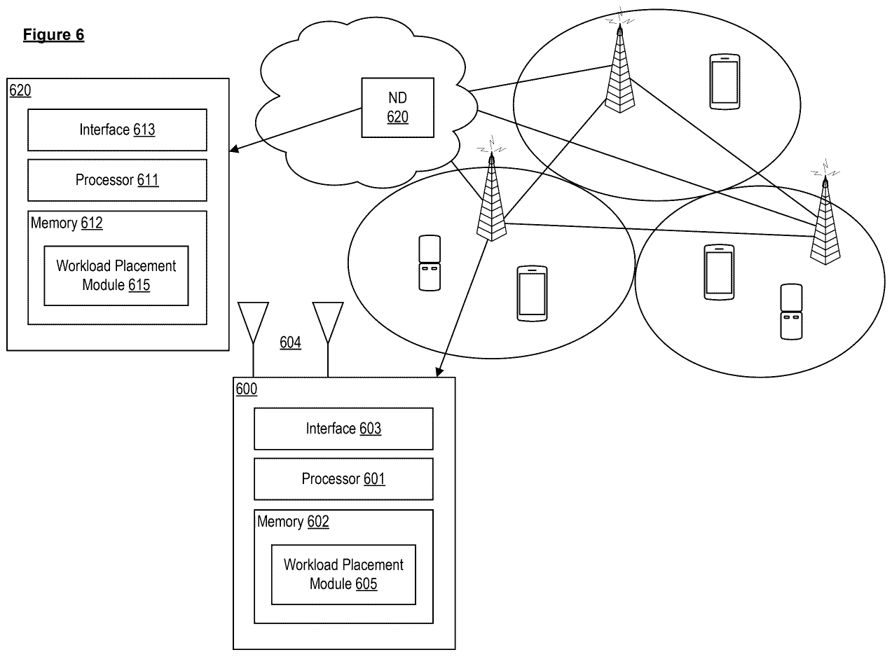

FIG. 6 is a diagram showing a mobile network that includes network devices that can implement embodiments disclosed herein.

Network device (ND) 600 may, in some embodiments, be an electronic device that can be communicatively connected to other electronic devices on the network (e.g., other network devices, user equipment devices (UEs), radio base stations, etc.). In certain embodiments, network device 600 may include radio access features that provide wireless radio network access to other electronic devices (for example a “radio access network device” may refer to such a network device) such as user equipment devices (UEs). For example, network device 600 may be a base station, such as eNodeB in Long Term Evolution (LTE), NodeB in Wideband Code Division Multiple Access (WCDMA) or other types of base stations, as well as a Radio Network Controller (RNC), a Base Station Controller (BSC), or other types of control nodes. As depicted in FIG. 6, the example network device 600 comprises processor 601, memory 602, interface 603, and antenna 604. These components may work together to provide various network device functionality as disclosed herein.

Processor 601 may be a microprocessor, controller, microcontroller, central processing unit, digital signal processor, application specific integrated circuit, field programmable gate array, any other type of electronic circuitry, or any combination of one or more of the preceding. The processor 601 may comprise one or more processor cores. In particular embodiments, some or all of the functionality described herein as being provided by network device 600 may be implemented by processor 601 executing software instructions, either alone or in conjunction with other network device 600 components, such as memory 602.

Memory 602 may store code (which is composed of software instructions and which is sometimes referred to as computer program code or a computer program) and/or data using non-transitory machine-readable (e.g., computer-readable) media, such as machine-readable storage media (e.g., magnetic disks, optical disks, solid state drives, read only memory (ROM), flash memory devices, phase change memory) and machine-readable transmission media (e.g., electrical, optical, radio, acoustical or other form of propagated signals—such as carrier waves, infrared signals). For instance, memory 602 may comprise non-volatile memory containing code to be executed by processor 601. Where memory 602 is non-volatile, the code and/or data stored therein can persist even when the network device is turned off (when power is removed). In some instances, while network device 600 is turned on that part of the code that is to be executed by the processor(s) 601 may be copied from non-volatile memory into volatile memory (e.g., dynamic random access memory (DRAM), static random access memory (SRAM)) of network device 600.

Interface 603 may be used in the wired and/or wireless communication of signaling and/or data to or from network device 600. For example, interface 603 may perform any formatting, coding, or translating to allow network device 600 to send/transmit and receive data whether over a wired and/or a wireless connection. In some embodiments, interface 603 may comprise radio circuitry capable of receiving data from other devices in the network over a wireless connection and/or sending/transmitting data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas 604 to the appropriate recipient(s). In some embodiments, interface 603 may comprise network interface controller(s) (NICs), also known as a network interface card, network adapter, local area network (LAN) adapter or physical network interface. The NIC(s) may facilitate in connecting the network device 600 to other devices allowing them to communicate via wire through plugging in a cable to a physical port connected to a NIC. In particular embodiments, processor 601 may represent part of interface 603, and some or all of the functionality described as being provided by interface X103 may be provided more specifically by processor 601.

The components of network device 600 are each depicted as separate boxes located within a single larger box for reasons of simplicity in describing certain aspects and features of network device 600 disclosed herein. In practice however, one or more of the components illustrated in the example network device 600 may comprise multiple different physical elements (e.g., interface 603 may comprise terminals for coupling wires for a wired connection and a radio transceiver for a wireless connection).

The solution described herein may be implemented in the network device 600 by means of a computer program comprising instructions which, when executed on at least one processor, cause the at least one processor to carry out the actions according to any of the above features and embodiments, where appropriate. For example, memory 602 may include a workload placement module 605 that when executed by processor 601 causes the ND 600 to perform operations for participating in a placement determination process for a data processing workload, as described herein above.

While the modules are illustrated as being implemented in software stored in memory 602, other embodiments implement part or all of each of these modules in hardware.

As depicted in FIG. 6, the example network device 620 comprises processor 611, memory 612, and interface 613. These components may work together to implement functionality of node in a mobile network, as described herein. The processor 611, memory 612, and interface 613 may be similar to the processor 601, memory 602, and interface 603 described above.

The solution described herein may be implemented in the network device 620 by means of a computer program comprising instructions which, when executed on at least one processor, cause the at least one processor to carry out the actions according to any of the above features and embodiments, where appropriate. For example, memory 612 may include a workload placement module 615 that when executed by processor 611 causes the ND 620 to perform operations for participating in a placement determination process for a data processing workload, as described herein above.

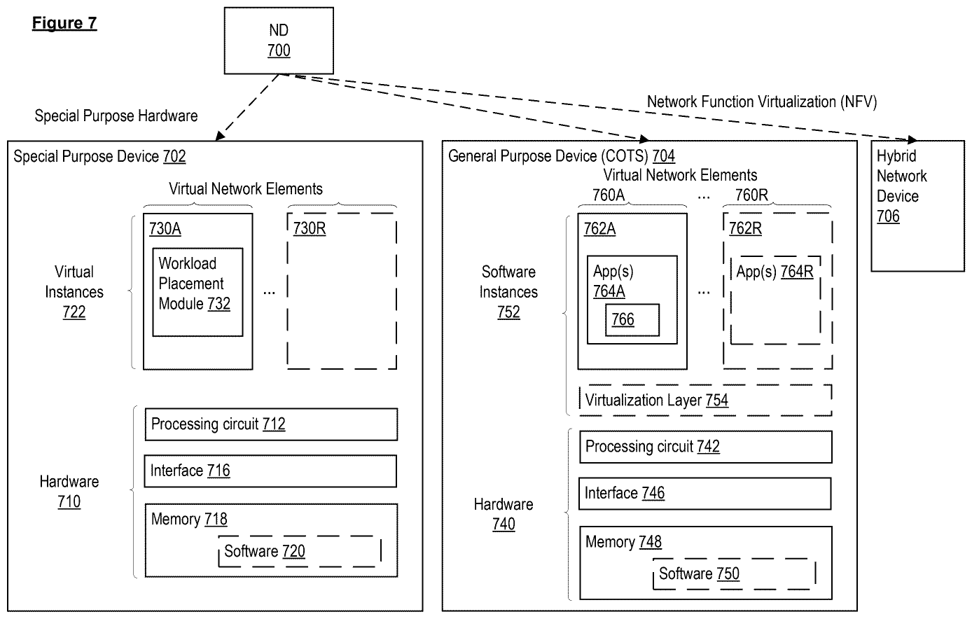

For a more thorough description of the example embodiment of network devices 600 and 620 described in FIG. 6, turn to FIG. 7 below.

FIG. 7 illustrates two specific examples of how ND 600 and/or ND 620 (represented in the diagram as ND 700) may be implemented in certain embodiments of the described solution including: 1) a special-purpose network device 702 that uses custom processing circuits such as application-specific integrated-circuits (ASICs) and a proprietary operating system (OS); and 2) a general purpose network device 704 that uses common off-the-shelf (COTS) processors and a standard OS which has been configured to provide one or more of the features or functions disclosed herein.

Special-purpose network device 702 includes hardware 710 comprising processor(s) 712, and interface 716, as well as memory 718 having stored therein software 720. In one embodiment, the software 720 implements the modules described with regard to the previous figures. During operation, the software 720 may be executed by the hardware 710 to instantiate a set of one or more software instance(s) 722. Each of the software instance(s) 722, and that part of the hardware 710 that executes that software instance (be it hardware dedicated to that software instance, hardware in which a portion of available physical resources (e.g., a processor core) is used, and/or time slices of hardware temporally shared by that software instance with others of the software instance(s) 722), form a separate virtual network element 730A-R. Thus, in the case where there are multiple virtual network elements 730A-R, each operates as one of the network devices from the preceding figures.

In an embodiment, a virtual network element 730A executes a workload placement module 732 to perform operations of one or more embodiments disclosed herein (e.g., operations to participate in a placement determination process for a data processing workload).

Returning to FIG. 7, the example general purpose network device 704 includes hardware 740 comprising a set of one or more processor(s) 742 (which are often COTS processors) and interface 746, as well as memory 748 having stored therein software 750. During operation, the processor(s) 742 execute the software 750 to instantiate one or more sets of one or more applications 764A-R. While certain embodiments do not implement virtualization, alternative embodiments may use different forms of virtualization. For example, in certain alternative embodiments virtualization layer 754 represents the kernel of an operating system (or a shim executing on a base operating system) that allows for the creation of multiple instances 762A-R called software containers that may each be used to execute one (or more) of the sets of applications 764A-R. In this embodiment, software containers 762A-R (also called virtualization engines, virtual private servers, or jails) are user spaces (typically a virtual memory space) that may be separate from each other and separate from the kernel space in which the operating system is run. In certain embodiments, the set of applications running in a given user space, unless explicitly allowed, may be prevented from accessing the memory of the other processes. In other such alternative embodiments virtualization layer 754 may represent a hypervisor (sometimes referred to as a virtual machine monitor (VMM)) or a hypervisor executing on top of a host operating system; and each of the sets of applications 764A-R may run on top of a guest operating system within an instance 762A-R called a virtual machine (which in some cases may be considered a tightly isolated form of software container that is run by the hypervisor). In certain embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 740, directly on a hypervisor (in which case the unikernel is sometimes described as running within a LibOS virtual machine), or in a software container, embodiments can be implemented fully with unikernels running directly on a hypervisor represented by virtualization layer 754, unikernels running within software containers represented by instances 762A-R, or as a combination of unikernels and the above-described techniques (e.g., unikernels and virtual machines both run directly on a hypervisor, unikernels and sets of applications that are run in different software containers).

The instantiation of the one or more sets of one or more applications 764A-R, as well as virtualization if implemented are collectively referred to as software instance(s) 752. Each set of applications 764A-R, corresponding virtualization construct (e.g., instance 762A-R) if implemented, and that part of the hardware 740 that executes them (be it hardware dedicated to that execution and/or time slices of hardware temporally shared by software containers 762A-R), forms a separate virtual network element(s) 760A-R.

The virtual network element(s) 760A-R perform similar functionality to the virtual network element(s) 730A-R. This virtualization of the hardware 740 is sometimes referred to as network function virtualization (NFV)). Thus, NFV may be used to consolidate many network equipment types onto industry standard high volume server hardware, physical switches, and physical storage, which could be located in for example data centers and customer premise equipment (CPE). However, different embodiments may implement one or more of the software container(s) 762A-R differently. While embodiments are illustrated with each instance 762A-R corresponding to one VNE 760A-R, alternative embodiments may implement this correspondence at a finer level granularity; it should be understood that the techniques described herein with reference to a correspondence of instances 762A-R to VNEs also apply to embodiments where such a finer level of granularity and/or unikernels are used.

In an embodiment, a virtual network element 760A executes a workload placement module 766 (e.g., which may be a module of an application 764A) to perform operations of one or more embodiments disclosed herein (e.g., operations to participate in a placement determination process for a data processing workload).

The third exemplary ND implementation in FIG. 7 is a hybrid network device 706, which includes both custom ASICs/proprietary OS and COTS processors/standard OS in a single ND or a single card within an ND. In certain embodiments of such a hybrid network device, a platform virtual machine (VM), such as a VM that that implements the functionality of the special-purpose network device 702, could provide for para-virtualization to the hardware present in the hybrid network device 706.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments are not described with reference to any particular programming language. It will be appreciated that a variety of programming languages may be used to implement the teachings of embodiments as described herein.

An embodiment may be an article of manufacture in which a non-transitory machine-readable storage medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

Throughout the description, embodiments have been presented through flow diagrams. It will be appreciated that the order of transactions and transactions described in these flow diagrams are only intended for illustrative purposes and not intended to be limiting. One having ordinary skill in the art would recognize that variations can be made to the flow diagrams.

In the foregoing specification, embodiments have been described with reference to specific exemplary embodiments thereof. It will be evident that various modifications may be made thereto without departing from the broader spirit and scope of the disclosure provided herein. The specification and drawings are, accordingly, to be regarded in an illustrative sense rather than a restrictive sense.

1. A method performed by a first node in a network to participate in a placement determination process for a data processing workload, the data processing workload to process data originating from or near an originating node for the data processing workload, the method comprising:
determining that the first node is to participate in a placement determination process for the data processing workload;
responsive to determining that the first node is to participate in the placement determination process for the data processing workload, determining, for each of one or more upstream nodes, whether a forwarding condition for the upstream node is satisfied based on metadata associated with the data processing workload;
transmitting, to each of one or more upstream nodes that satisfy the forwarding condition, a placement request that includes the metadata associated with the data processing workload;
receiving, from each of the one or more upstream nodes that satisfy the forwarding condition, a placement response; and
determining a node having a minimal cost based on information included in the placement responses received from the one or more upstream nodes that satisfy the forwarding condition.

2. The method of claim 1, wherein the determination that the first node is to participate in the placement determination process for the data processing workload is based on receiving, from a downstream node, a placement request for the data processing workload, wherein the placement request received from the downstream node includes a local state and the metadata associated with the data processing workload, wherein determining whether the forwarding condition is satisfied for an upstream node is further based on the local state included in the placement request received from the downstream node.

3. The method of claim 2, further comprising:
transmitting, to the downstream node, a placement response that includes information regarding the node determined by the first node as having a minimal cost.

4. The method of claim 3, wherein the local state included in the placement request received from the downstream node includes an aggregated link metric.

5. The method of claim 4, wherein the metadata associated with the data processing workload includes an identifier associated with the data processing workload, a computing requirement for the data processing workload, and a link requirement for the data processing workload.

6. The method of claim 5, wherein the local state included in the placement request received from the downstream node further includes a current distance from the originating node and the metadata associated with the data processing workload further includes a maximum allowed distance.

7. The method of claim 6, wherein the determination of whether the forwarding condition is satisfied for an upstream node comprises:
determining whether the upstream node has already been visited;
determining whether the aggregated link metric satisfies the link requirement for the data processing workload;
determining whether the link between the first node and the upstream node has sufficient bandwidth; and
determining whether the maximum allowed distance has been reached.

8. The method of claim 7, wherein the aggregated link metric includes one or more of: an aggregated link latency, an aggregated link loss, and an aggregated link jitter.

9. The method of claim 1,
wherein the determination that the first node is to participate in the placement determination process for the data processing workload is based on determining that the first node is to initiate the placement determination process for the data processing workload because the first node is the originating node.

10. The method of claim 9, further comprising:
responsive to determining that the first node initiated the placement determination process for the data processing workload, causing the data processing workload to be placed on the node determined by the first node as having a minimal cost.

11. The method of claim 1, further comprising:
receiving, from a downstream node, a placement request for a second data processing workload;
determining, for each of one or more upstream nodes, whether the forwarding condition for the upstream node is satisfied based on a local state included in the placement request received from the downstream node and metadata associated with the second data processing workload; and
responsive to determining that there are no upstream nodes that satisfy the forwarding condition, transmitting a placement response to the downstream node without transmitting any placement requests to upstream nodes.

12. The method of claim 1, wherein the first node is a cloud computing node of a mobile network.

13. A non-transitory machine-readable medium comprising computer program code which when executed by a network device functioning as a first node in a network, causes the network device to perform steps of:
determining that the first node is to participate in a placement determination process for the data processing workload;
responsive to determining that the first node is to participate in the placement determination process for the data processing workload, determining, for each of one or more upstream nodes, whether a forwarding condition for the upstream node is satisfied based on metadata associated with the data processing workload;
transmitting, to each of one or more upstream nodes that satisfy the forwarding condition, a placement request that includes the metadata associated with the data processing workload;
receiving, from each of the one or more upstream nodes that satisfy the forwarding condition, a placement response; and
determining a node having a minimal cost based on information included in the placement responses received from the one or more upstream nodes that satisfy the forwarding condition.

14. A network device to function as a first node in a network to participate in a placement determination process for a data processing workload, the network device comprising:
one or more processors and
a non-transitory machine-readable storage medium that stores instructions, which when executed by the one or more processors, causes the first node to perform steps of:
determining that the first node is to participate in a placement determination process for the data processing workload;
responsive to determining that the first node is to participate in the placement determination process for the data processing workload, determining, for each of one or more upstream nodes, whether a forwarding condition for the upstream node is satisfied based on metadata associated with the data processing workload;
transmitting, to each of one or more upstream nodes that satisfy the forwarding condition, a placement request that includes the metadata associated with the data processing workload;
receiving, from each of the one or more upstream nodes that satisfy the forwarding condition, a placement response; and
determining a node having a minimal cost based on information included in the placement responses received from the one or more upstream nodes that satisfy the forwarding condition.
